(19) United States
(12) Patent Application Publication
(10) Pub. No.: US 2023/0008696 A1
(43) Pub. Date: Jan. 12, 2023

(54) METHOD FOR INCREMENTING SAMPLE IMAGE

(71) Applicant: Beijing Baidu Netcom Science Technology Co., Ltd., Beijing (CN)

(72) Inventors: Yunhao WANG, Beijing (CN); Bin ZHANG, Beijing (CN); Ying XIN, Beijing (CN); Yuan FENG, Beijing (CN); Shumin HAN, Beijing (CN)

(21) Appl. No.: 17/939,364

(22) Filed: Sep. 7, 2022

Related U.S. Application Data
(63) Continuation of application No. PCT/CN2022/075152, filed on Jan. 30, 2022.

(30) Foreign Application Priority Data
Apr. 7, 2021 (CN) 202110371342.4

(51) Int. Cl. G06T 5/00; G06V 10/22; G06V 10/774; G06T 5/50

(52) U.S. Cl. CPC G06T 5/002; G06V 10/22; G06V 10/774; G06T 5/50; G06T 2207/20076; G06T 2207/20081; G06T 2207/30168; G06T 2207/20084

(57) ABSTRACT

The present disclosure provides a method for incrementing a sample image, an electronic device, and a computer readable storage medium. A specific implementation comprises: acquiring a first convolutional feature of an original sample image; determining, according to a region generation network and the first convolutional feature, a candidate region and a first probability that the candidate region contains a target object; determining a target candidate region from the candidate region based on the first probability, and mapping the target candidate region back to the original sample image to obtain an intermediate image; and performing image enhancement processing on a portion of the intermediate image corresponding to the target candidate region and/or performing image blur processing on a portion of the intermediate image corresponding to a non-target candidate region to obtain an incremental sample image.

### CROSS-REFERENCE TO RELATED APPLICATION

This patent application is a U.S. continuation of international application serial No. PCT/CN2022/075152 filed on Jan. 30, 2022, which claims the priority of Chinese Patent Application No. 202110371342.4, filed on Apr. 7, 2021 and entitled “METHOD FOR INCREMENTING SAMPLE IMAGE, METHOD FOR TRAINING IMAGE DETECTION MODEL, AND METHOD FOR DETECTING IMAGE”, the entire disclosures of which are hereby incorporated by reference.

### TECHNICAL FIELD

The present disclosure relates to the field of artificial intelligence, specifically to computer vision and deep learning technologies, and particularly to a method for incrementing a sample image, an electronic device and a computer readable storage medium, and can be applied to intelligent cloud and industrial quality inspection scenarios.

### BACKGROUND

In the field of target detections, machine learning algorithms often need to learn from a large number of annotated training samples, so as to use trained models to perform target detections on actual samples.

In some technical fields, due to the scarcity or extremely difficult acquisition of target objects, it is difficult to collect enough training samples, and thus, the identification capabilities of the trained models cannot be guaranteed.

In the existing technologies, the increments of small samples are typically implemented by performing transforms such as rotating sample images, or based on generative adversarial networks, or through transfer learning.

### SUMMARY

Embodiments of the present disclosure provide a method for incrementing a sample image, an electronic device, and a computer readable storage medium.

According to a first aspect, embodiments of the present disclosure provide a method for incrementing a sample image, which includes: acquiring a first convolutional feature of an original sample image; determining, according to a region generation network and the first convolutional feature, a candidate region and a first probability that the candidate region contains a target object; determining a target candidate region from the candidate region based on the first probability, and mapping the target candidate region back to the original sample image to obtain an intermediate image; and performing image enhancement processing on a portion of the intermediate image corresponding to the target candidate region and/or performing image blur processing on a portion of the intermediate image corresponding to a non-target candidate region to obtain an incremental sample image.

According to a second aspect, embodiments of the present disclosure provide an electronic device, which includes: at least one processor; and a storage device in communication with the at least one processor, where the storage device stores instructions executable by the at least one processor, and the instructions, when executed by the at least one processor, to cause the at least one processor to perform the method for incrementing a sample image as described in any implementations of the first aspect.

According to a third aspect, embodiments of the present disclosure provide a non-transitory computer readable storage medium storing computer instructions, where the computer instruction are used to cause a computer to perform the method for incrementing a sample image as described in any implementations of the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

After reading the detailed descriptions of non-limiting embodiments given with reference to the following accompanying drawings, other features, objectives and advantages of the present disclosure will be more apparent.

FIG. 1 illustrates an exemplary system architecture in which the present disclosure may be applied;

FIG. 2 is a flowchart of a method for incrementing a sample image provided by an embodiment of the present disclosure;

FIG. 3 is a flowchart of another method for incrementing a sample image provided by an embodiment of the present disclosure;

FIG. 4 is a flowchart of a method for training an image detection model provided by an embodiment of the present disclosure;

FIG. 5 a schematic flow diagram of a method for incrementing a sample image in an application scenario, provided by an embodiment of the present disclosure;

FIG. 6 is a structure block diagram of an apparatus for incrementing a sample image provided by an embodiment of the present disclosure;

FIG. 7 is a structure block diagram of an apparatus for training an image detection model provided by an embodiment of the present disclosure;

FIG. 8 is a structure block diagram of an apparatus for detecting an image provided by an embodiment of the present disclosure; and

FIG. 9 is a schematic structural diagram of an electronic device provided by an embodiment of the present disclosure and adapted to perform the method for incrementing a sample image, and/or the method for training an image detection model, and/or the method for detecting an image.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions of well-known functions and structures are omitted in the following description. It should be noted that the embodiments in the present disclosure and the features in the embodiments may be combined with each other on a non-conflict basis.

In the technical solution of the present disclosure, the acquisition, storage, application, etc. of the user personal information all comply with the provisions of the relevant laws and regulations, necessary confidentiality measures are taken, and public order and good customs are not violated.

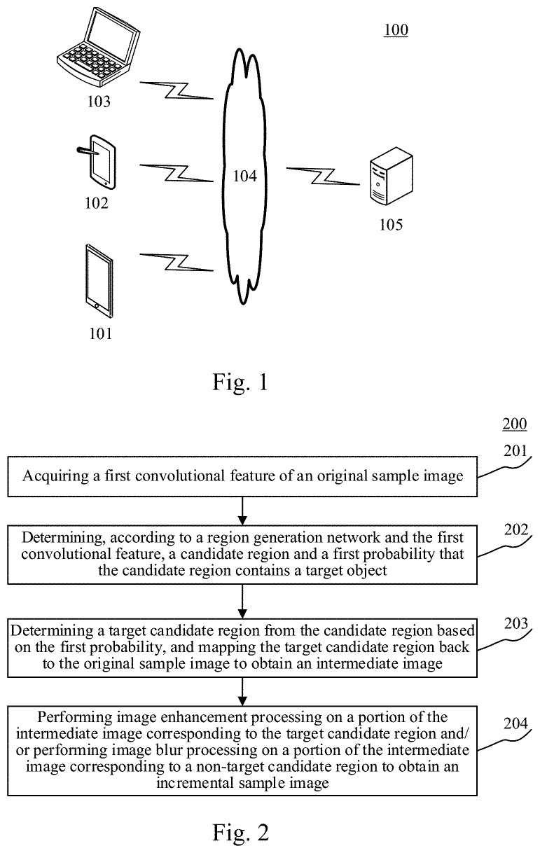

First, FIG. 1 illustrates an exemplary system architecture 100 in which embodiments of a method for incrementing a sample image, a method for training an image detection model, a method for detecting an image, corresponding apparatuses, an electronic device and a computer readable storage medium according to the present disclosure may be applied.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, for example, wired or wireless communication links, or optical fiber cables.

A user may use the terminal devices 101, 102 and 103 to interact with the server 105 via the network 104 to receive or send messages, etc. On the terminal devices 101, 102 and 103 and the server 105, various applications for implementing information communications between the terminal devices 101, 102 and 103 and the server 105 may be installed (e.g., an image transmission application, a sample image incremental application, and a target detection model training application).

The terminal devices 101, 102 and 103 and the server 105 may be hardware or software. When being the hardware, the terminal devices 101, 102 and 103 may be various electronic devices having a display screen, the electronic devices including, but not limited to, a smart phone, a tablet computer, a laptop portable computer, a desktop computer, etc. When being the software, the terminal devices 101, 102 and 103 may be installed on the above listed electronic devices. The terminal devices 101, 102 and 103 may be implemented as a plurality of pieces of software or a plurality of software modules, or as a single piece of software or a single software module, which will not be specifically limited here. When being the hardware, the server 105 may be implemented as a distributed server cluster composed of a plurality of servers, or may be implemented as a single server. When being the software, the server may be implemented as a plurality of pieces of software or a plurality of software modules, or may be implemented as a single piece of software or a single software module, which will not be specifically limited here.

The server 105 can provide various services through various built-in applications. Taking an image incremental application capable of providing a sample image incremental service as an example, the server 105 can achieve the following effects when running the image incremental application. First, an original sample image is received from the terminal devices 101, 102 and 103 via the network 104, and then, a first convolutional feature of the original sample image is extracted through a conventional feature extraction network. Then, according to a region generation network and the first convolutional feature, a candidate region and a first probability that the candidate region contains a target object are determined. Next, a target candidate region is determined from the candidate region based on the first probability, and the target candidate region is mapped back to the original sample image to obtain an intermediate image. Finally, image enhancement processing is performed on a portion of the intermediate image corresponding to the target candidate region, and/or image blur processing is performed on a portion of the intermediate image corresponding to a non-target candidate region, to obtain an incremental sample image.

Further, the server 105 may further train a corresponding image detection model using the generated incremental sample image. For example, the server 105 can achieve the following effects when running a model training application. A second convolutional feature of the incremental sample image is acquired. According to the region generation network and the second convolutional feature, a new candidate region and a second probability that the new candidate region contains the target object are determined. A first loss value corresponding to the first probability and a second loss value corresponding to the second probability are acquired. An integrated loss value is determined based on a weighted first loss value and a weighted second loss value. A trained image detection model is obtained on a basis that the integrated loss value satisfies a preset requirement.

Further, after obtaining the trained image detection model according to the above training method, the server 105 may further provide an image detection service based on the image detection model externally, that is, detect a to-be-detected image by calling the image detection model, and return the detection result.

It should be pointed out that, in addition to being acquired from the terminal devices 101, 102 and 103 via the network 104, the original sample image can be pre-stored locally in the server 105 in various ways. Therefore, when detecting that these data has been stored locally (e.g., a previously retained to-be-processed incremental sample image task before the processing starts), the server 105 can choose to directly acquire these data locally. In such a case, the exemplary system architecture 100 may not include the terminal devices 101, 102 and 103 and the network 104. Further, the first convolutional feature of the original sample image may alternatively be extracted through a feature extraction network in advance, and then the extracted first convolutional feature will be directly used.

Since incrementing an image requires many computing resources and a strong computing capability, the method for incrementing a sample image provided in the subsequent embodiments of the present disclosure is generally performed by the server 105 having a strong computing capability and many computing resources, and correspondingly, the apparatus for incrementing a sample image is generally provided in the server 105. However, meanwhile, it should be pointed out that, when the terminal devices 101, 102 and 103 also have a computing capability and computing resources that meet the requirements, the terminal devices 101, 102 and 103 can also, through the image incremental application installed on the terminal devices 101, 102 and 103, complete the above computations that should have been completed by the server 105, thus outputting the same result as the server 105. Particularly, when there are many terminal devices with different computing capabilities at the same time, but the image incremental application determines that the terminal device on which the application is installed has a strong computing capability and many remaining computing resources, it is possible to make the terminal device perform the above computations, which appropriately reduces the computation stress of the server 105. Correspondingly, the apparatus for incrementing a sample image may alternatively be provided in the terminal devices 101, 102 and 103. In such a case, the exemplary system architecture 100 may not include the server 105 and the network 104.

It should be appreciated that the numbers of the terminal devices, the network, and the server in FIG. 1 are merely illustrative. Any number of terminal devices, networks, and servers may be provided based on actual requirements.

According to the method for incrementing a sample image, the method for training an image detection model, the method for detecting an image, the corresponding apparatuses, the electronic device, the computer readable storage medium and the computer program product that are provided in the embodiments of the present disclosure, first, the first convolutional feature of the original sample image is acquired; then, the candidate region and the first probability that the candidate region contains the target object are determined according to the region generation network and the first convolutional feature; next, the target candidate region is determined from the candidate region based on the first probability, and the target candidate region is mapped back to the original sample image to obtain the intermediate image; and finally, the image enhancement processing is performed on the portion of the intermediate image corresponding to the target candidate region, and/or the image blur processing is performed on the portion of the intermediate image corresponding to the non-target candidate region to obtain the incremental sample image.

In the technical solution provided by the present disclosure, the candidate region that is likely to contain the target object is determined by means of the region generation network, and then the candidate region with a high probability is used as the target candidate region. By mapping the target candidate region back to the original image, and performing correspondingly sharpening on the portion of the original image corresponding to the target candidate region and/or blurring on the portion of the original image corresponding to the non-target candidate region, the incremental sample image that highlights the target object as much as possible is obtained. Through this technical solution, an incremental sample image with a high availability can be generated under the premise of not destroying the key part of the original sample image.

Referring to FIG. 2, FIG. 2 is a flowchart of a method for incrementing a sample image provided by an embodiment of the present disclosure. Here, a flow 200 includes the following steps:

Step 201, acquiring a first convolutional feature of an original sample image.

This step is intended to acquire, by an executing body of the method for incrementing a sample image (e.g., the server 105 shown in FIG. 1), the first convolutional feature of the original sample image.

Here, the first convolutional feature may be extracted from the original sample image through a feature extraction network, and the specific type of the feature extraction network is not limited. The original sample image is an image containing a target object, and depending on actual requirements, the target object may refer to various objects in a small-sample scenario, such as, a crack in a metal material and a microbe in a certain moving state under a microscope.

Step 202, determining, according to a region generation network and the first convolutional feature, a candidate region and a first probability that the candidate region contains a target object.

Based on step 201, this step is intended to input, by the above executing body, the first convolutional feature into the region generation network, to determine, using the region generation network, a candidate region suspected to contain the target object, and the first probability that each candidate region contains the target object. Specifically, the first probability is used to describe a likelihood that the candidate region does contain the target object, and even to quantify the likelihood to a probability score. It should be appreciated that the candidate region is a region that is determined by the region generation network based on the convolutional feature (map) and is likely to contain the target object. That is, the region generation network should have a capability to identify the convolutional feature of the target object.

Step 203, determining a target candidate region from the candidate region based on the first probability, and mapping the target candidate region back to the original sample image to obtain an intermediate image.

Based on step 202, this step is intended to determine, by the above executing body, a candidate region having a high probability of containing the target object from the candidate region according to the first probability of the candidate region, and use this candidate region as the target candidate region, and further map the target candidate region back to the original sample image, thereby obtaining an intermediate image in which a suspected target object is bounded.

It should be understood that since the candidate region is determined based on the convolutional feature (map) extracted from the original sample image, the candidate region is a region in the convolutional feature map and is not a region directly in the original sample image. However, the target candidate region can be mapped back into the original sample image by means of the corresponding relationship between the convolutional feature and the original sample image, thereby outlining the existence boundary of the target object in the original sample image. However, it should be understood that the accuracy of the outlining of the existence boundary of the target object depends on the accuracy of the candidate region extracted by the region generation network and the accuracy of the determined first probability.

Step 204, performing image enhancement processing on a portion of the intermediate image corresponding to the target candidate region and/or performing image blur processing on a portion of the intermediate image corresponding to a non-target candidate region to obtain an incremental sample image.

Based on step 203, this step is intended to perform, by the above executing body, different image processing on the bounded portion of the intermediate image where the target object is and/or the portion of the intermediate image where there is no target object, thus obtaining the incremental sample image.

Specifically, this step includes three different implementations:

The first one is: the image enhancement processing is performed only on the portion of the intermediate image corresponding to the target candidate region, and the intermediate image obtained after the image enhancement processing is used as the incremental sample image.

The second one is: the image blur processing is performed only on the portion of the intermediate image corresponding to the non-target candidate region, and the intermediate image obtained after the image blur processing is used as the incremental sample image.

The third one is: the image enhancement processing is performed on the portion of the intermediate image corresponding to the target candidate region, the image blur processing is performed on the portion of the intermediate image corresponding to the non-target candidate region, and the intermediate image obtained after the image enhancement processing and the image blur processing is used as the incremental sample image.

Each of the above implementations is intended to highlight the partial region where the target object is as much as possible.

It should be understood that the image enhancement processing is an image processing means of improving the definition of an image, and the image blur processing is an image processing means of reducing the definition of the image. The clearer the image is, the easier it is to accurately identify whether the target object is contained.

The embodiment of the present disclosure provides a method for incrementing a sample image. According to the method, the candidate region that is likely to contain the target object is determined by means of the region generation network, and then the candidate region with a high probability is used as the target candidate region. By mapping the target candidate region back to the original image, and performing correspondingly sharpening on the portion of the original image corresponding to the target candidate region and/or blurring on the portion of the original image corresponding to the non-target candidate region, the incremental sample image that highlights the target object as much as possible is obtained. Through this technical solution, an incremental sample image with a high availability can be generated under the premise of not destroying the key part of the original sample image.

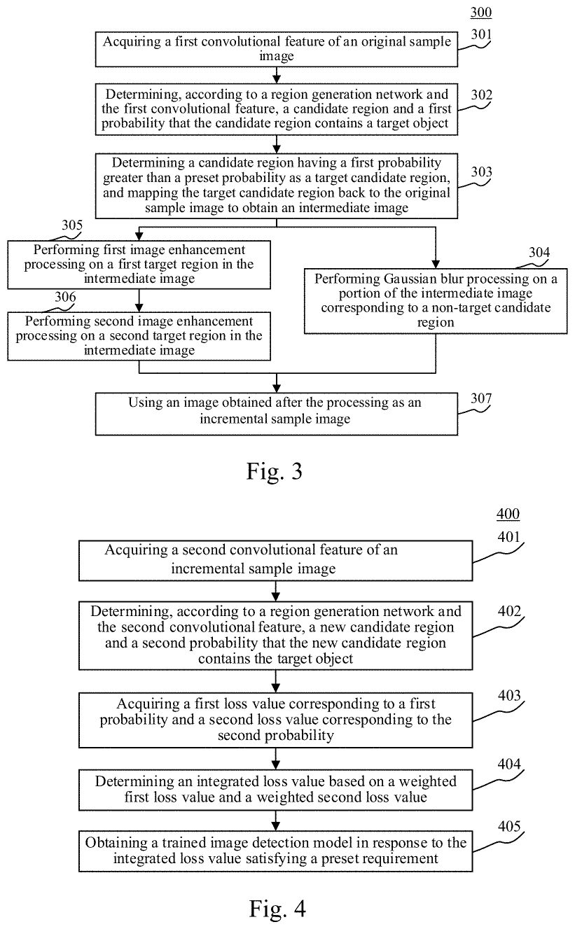

Referring to FIG. 3, FIG. 3 is a flowchart of another method for incrementing a sample image provided by an embodiment of the present disclosure. Here, a flow 300 includes the following steps:

Step 301, acquiring a first convolutional feature of an original sample image.

Step 302, determining, according to a region generation network and the first convolutional feature, a candidate region and a first probability that the candidate region contains a target object.

The above steps 301-302 are consistent with steps 201-202 shown in FIG. 2. For the contents of the same parts, reference is made to the corresponding parts of the previous embodiment, and thus, the details will not be repeatedly described here.

Step 303, determining a candidate region having a first probability greater than a preset probability as a target candidate region, and mapping the target candidate region back to the original sample image to obtain an intermediate image.

Based on step 203, this embodiment provides a specific implementation of selecting a target candidate region through this step, that is, by pre-setting a preset probability (e.g., 70%) which is considered to distinguish high and low probabilities. Therefore, it is only required to compare the first probability of each candidate region with the preset probability to select a high probability of a target candidate region having the target object.

In addition to the approach of determining the target candidate region based on the preset probability provided in step 303, an approach of determining candidate regions having first probabilities of which the values are top ranked (ranked in a descending order, top N refers to N candidate regions having a large probability value) as the target candidate regions may be selected, or an approach of determining the target candidate region based on a top-ranked percentage may be selected. That is, each of the approaches is intended to determine a candidate region having a high probability of containing the target object as the target candidate region, such that the target object in the original sample image can be bounded as accurately as possible after the target candidate region is mapped back to the original sample image.

Step 304, performing Gaussian blur processing on a portion of the intermediate image corresponding to a non-target candidate region.

Based on step 303, this step is intended to, by the above executing body, perform the Gaussian blur processing on the portion of the intermediate image corresponding to the non-target candidate region.

Gaussian blur, also known as Gaussian smoothing, is typically used to reduce image noise and reduce the level of detail. The image generated through this blur technique has a visual effect as if the image is viewed through frosted glass. This effect is distinctly different from the bokeh effect produced by an out-of-focus lens or the effect of the shadow of an object under usual illumination. Gaussian smoothing is also used in the pre-processing stage in computer vision algorithms to enhance the image effects of the image at different scales. From a mathematical point of view, the Gaussian blurring process of an image is a convolution of the image and a normal distribution. Since the normal distribution is also called Gaussian distribution, this technique is called a Gaussian blur. A more accurate out-of-focus imaging effect will be produced through the convolution of the image and a circular box blur. Since the Fourier transform of a Gaussian function is another Gaussian function, the Gaussian blur is a low-pass filter for the image.

Step 305, performing first image enhancement processing on a first target region in the intermediate image.

Step 306, performing second image enhancement processing on a second target region in the intermediate image.

Based on step 303, image enhancement processing of different image enhancement intensities is respectively performed on the first target region and the second target region in the intermediate image in steps 305 and 306, to distinguish the image enhancement effects of different target regions.

Here, the first target region is an overlapping portion of at least two target candidate regions mapped in the original sample image. Different from the first target region, the second target region is a portion of a single target candidate region mapped in the original sample image. It can be appreciated that the more the target candidate regions mapped at the same position in the original sample image are, the more accurate the determination for the existence of the target object at that position can be, and conversely, the accuracy of original determination can only be maintained. Therefore, through steps 305 and 306 in this embodiment, the image enhancement means of a high image enhancement intensity is used on the partial region that is more likely contain the target object, and a conventional image enhancement means is used on the partial region having a general possibility of containing the target object.

Step 307, using the image obtained after the processing as an incremental sample image.

On the basis of the technical solution provided in the previous embodiment, this embodiment provides, through step 303, a specific method of determining the target candidate region based on the first probability; provides, through step 304, an image blur processing approach in which a Gaussian blur is used on the portion of the intermediate image corresponding to the non-target candidate region; and provides, through steps 305-306, an approach in which the image enhancement processing of different image enhancement intensities are used according to whether the portion of the intermediate image corresponding to the non-target candidate region is an overlap of a plurality of target candidate regions so as to highlight the target object as much as possible.

It should be appreciated that the specific implementations provided in step 303, step 304, and steps 305-306 may be combined individually with the embodiment shown in the flow 200 to form different embodiments, and these embodiments have no causal and dependent relationships. Therefore, this embodiment is in fact only a preferred embodiment of the three specific implementations.

The above embodiments provide different solution for incrementing a sample image. Further, a model training method for training and obtaining a target detection model can be further provided in combination with the above technical solution of generating an incremental sample image. The method includes, but not limited to an implementation as shown in FIG. 4. The flow 400 includes the following steps:

Step 401, acquiring a second convolutional feature of an incremental sample image.

The second convolutional feature is extracted from the incremental sample image, and the approach of extracting the second convolutional feature is the same as the approach of extracting a first convolutional feature from an original sample image. For example, the same feature extraction network is used.

Step 402, determining, according to a region generation network and the second convolutional feature, a new candidate region and a second probability that the new candidate region contains the target object.

The new candidate region and the second probability thereof are similar to the candidate region and the first probability thereof, and the difference lies in that the new candidate region and the second probability are for the incremental sample image, and the candidate region and the first probability are for the original sample image.

Step 403, acquiring a first loss value corresponding to the first probability and a second loss value corresponding to the second probability.

Based on step 402, this step is intended to obtain loss values used to guide the training of a model. Since there are the original sample image and the incremental sample image, the corresponding loss values are respectively determined based on the first probability and the second probability.

Step 404, determining an integrated loss value based on a weighted first loss value and a weighted second loss value.

Based on step 403, this step is intended to integrate the weighted first loss value and the weighted second loss value to determine a more reasonable integrated loss value. Here, a weight value for weighting the first loss value and a weight value for weighting the second loss value may be the same or different, and may be flexibly adjusted according to actual situations.

Step 404 includes, but not limited to, an implementation: using a sum of the weighted first loss value and the weighted second loss value as the integrated loss value.

Step 405, obtaining a trained image detection model on a basis that the integrated loss value satisfies a preset requirement.

Based on step 404, this step is intended to obtain, by the above executing body, the trained image detection model on the basis that the integrated loss value satisfies the preset requirement.

Step 405 includes, but not limited to, an implementation: outputting the trained image detection model in response to the integrated loss value being a minimum value in the predetermined number of rounds of iterative training. This implementation can be understood as that the purpose of the training is to control the integrated loss value to be minimized. The smaller the integrated loss value is, the higher the detection precision of the model is.

On the basis of the previous embodiments, in the embodiment shown in FIG. 4, the target detection model is further trained in combination with the incremental sample image, so that the trained target detection model can be directly used to accurately and efficiently detect whether there is a target object in a to-be-detected image.

A method for detecting an image may be as follows:

A to-be-detected image is first received, and then, an image detection model is invoked to detect the to-be-detected image. Subsequently, an obtained detection result can be returned.

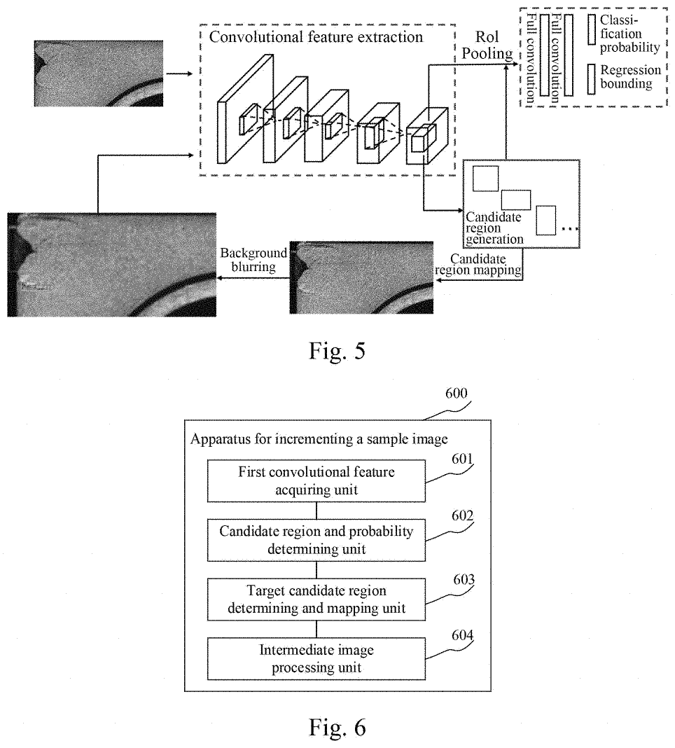

For a deeper understanding, the present disclosure further provides a specific implementation in combination with a specific application scenario. For details, reference is made to the schematic flow diagram shown in FIG. 5.

For a real target detection scenario in which the number of sample images is small, this embodiment provides a region generation enhancement-based target detection method. The method is intended to enhance data by using candidate region generation, and can be used together with various existing sample incremental techniques, thereby comprehensively improving the availability of incremental samples from different angles, and finally a target detection model having a better detection effect is trained based on an incremental sample set:

1) A convolutional feature of an original image A is extracted using a convolution neural network.

2) A candidate region that is likely to contain a target and a score of a probability that each candidate region is likely to contain the target are generated through a region generation network and the extracted convolutional feature.

3) After usual ROI (region of interest) pooling, the candidate region obtained in 2) and the convolutional feature extracted in 1) are inputted into two fully connected layers to obtain thousands of classification probabilities. Each classification probability has its corresponding regression boundary, which are denoted as a classification probability a1 and a regression boundary a2.

4) The candidate region obtained in 2) is sorted according to a descending order of probability score, and top N candidate regions are selected to be mapped back to the original image (N is 50, and this parameter can be adjusted according to a specific task), and thus, an intermediate image marked with N detection boxes can be obtained.

5) The region outside a detection box in the intermediate image obtained in (4) is denoted as a background region, a Gaussian blur is performed on the background region, and an image enhancement is performed on the foreground region inside the detection box to improve the sharpness, thus obtaining an image B.

6) The image B is inputted into the convolutional feature extraction network, and finally, a classification probability b1 and a regression boundary b2 can be obtained.

7) A weighted summation is performed on the classification probability a1 and a classification probability a2 to obtain a final classification probability, and the regression boundary corresponding to the classification probability (i.e., b1 and b2) are mapped into the to-be-detected original image according to a certain threshold, to obtain a final detection result.

Since a background blur is performed on the image obtained after the candidate region is mapped during the processing, only when the candidate region contains all to-be-detected targets in the image, the loss value of the image obtained after the candidate region is mapped is becoming more convergent during the training.

The above solution can also be transplanted to an existing region generation network-based method, and can improve the effect together with other techniques for a small sample detection, so as to further improve the practicability.

As implementations of the methods shown in the above drawings, the present disclosure further provides embodiments of apparatuses, that is, an apparatus for incrementing a sample image that corresponds to the method for incrementing a sample image shown in FIG. 2, an apparatus for training an image detection model that corresponds to the method for training an image detection model shown in FIG. 4, and an apparatus for detecting an image that corresponds to the method for detecting an image. The apparatuses may be applied in various electronic devices.

As shown in FIG. 6, the apparatus 600 for incrementing a sample image in this embodiment may include: a first convolutional feature acquiring unit 601, a candidate region and probability determining unit 602, a target candidate region determining and mapping unit 603 and an intermediate image processing unit 604. Here, the first convolutional feature acquiring unit 601 is configured to acquire a first convolutional feature of an original sample image. The candidate region and probability determining unit 602 is configured to determine, according to a region generation network and the first convolutional feature, a candidate region and a first probability that the candidate region contains a target object. The target candidate region determining and mapping unit 603 is configured to determine a target candidate region from the candidate region based on the first probability, and map the target candidate region back to the original sample image to obtain an intermediate image. The intermediate image processing unit 604 is configured to perform image enhancement processing on a portion of the intermediate image corresponding to the target candidate region and/or perform image blur processing on a portion of the intermediate image corresponding to a non-target candidate region to obtain an incremental sample image.

In this embodiment, for specific processes of the first convolutional feature acquiring unit 601, the candidate region and probability determining unit 602, the target candidate region determining and mapping unit 603 and the intermediate image processing unit 604 in the apparatus 600 for incrementing a sample image, and their technical effects, reference may be respectively made to relative descriptions of steps 201-204 in the corresponding embodiment of FIG. 2, and thus, the details will not be repeatedly described here.

In some alternative implementations of this embodiment, the intermediate image processing unit 604 may include: a blur processing subunit, configured to perform the image blur processing on the portion of the intermediate image corresponding to the non-target candidate region. The blur processing subunit is further configured to:

perform Gaussian blur processing on the portion of the intermediate image corresponding to the non-target candidate region.

In some alternative implementations of this embodiment, the target candidate region determining and mapping unit 603 may include: a target candidate region determining subunit, configured to determine the target candidate region from the candidate region based on the first probability. The target candidate region determining subunit is further configured to:

determine a candidate region having the first probability greater than a preset probability as the target candidate region.

In some alternative implementations of this embodiment, the intermediate image processing unit 604 may include: an enhancement processing subunit, configured to perform the image enhancement processing on the portion of the intermediate image corresponding to the target candidate region. The enhancement processing subunit is further configured to:

perform first image enhancement processing on a first target region in the intermediate image, where the first target region is an overlapping portion of at least two target candidate regions mapped in the original sample image; and

perform second image enhancement processing on a second target region in the intermediate image, where the second target region is a portion of a single target candidate region mapped in the original sample image, and an image enhancement intensity of the first image enhancement processing is greater than an image enhancement intensity of the second image enhancement processing.

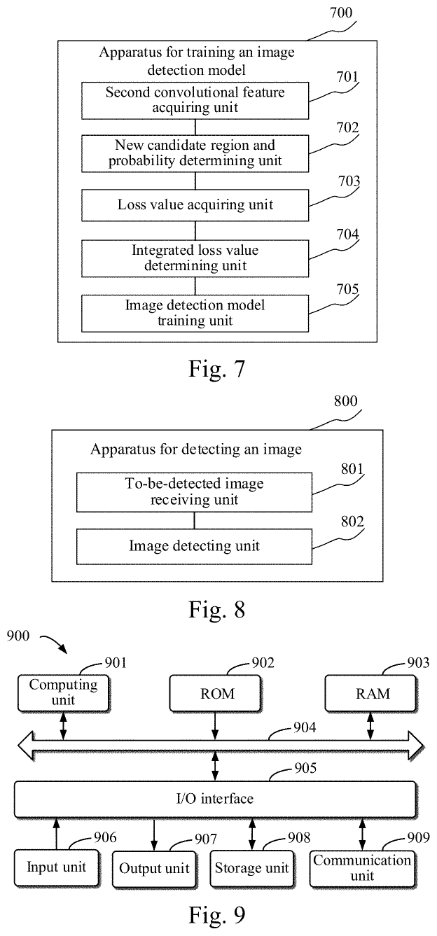

As shown in FIG. 7, the apparatus 700 for training an image detection model in this embodiment may include: a second convolutional feature acquiring unit 701, a new candidate region and probability determining unit 702, a loss value acquiring unit 703, an integrated loss value determining unit 704 and an image detection model training unit 705. Here, the second convolutional feature acquiring unit 701 is configured to acquire a second convolutional feature of an incremental sample image, the incremental sample image being obtained through the apparatus for incrementing a sample image shown in FIG. 6. The new candidate region and probability determining unit 702 is configured to determine, according to a region generation network and the second convolutional feature, a new candidate region and a second probability that the new candidate region contains a target object. The loss value acquiring unit 703 is configured to acquire a first loss value corresponding to a first probability and a second loss value corresponding to the second probability. The integrated loss value determining unit 704 is configured to determine an integrated loss value based on a weighted first loss value and a weighted second loss value. The image detection model training unit 705 is configured to obtain a trained image detection model on a basis that the integrated loss value satisfies a preset requirement.

In some alternative implementations of this embodiment, the integrated loss value determining unit is further configured to:

use a sum of the weighted first loss value and the weighted second loss value as the integrated loss value.

In some alternative implementations of this embodiment, the image detection model training unit is further configured to:

output the trained image detection model in response to the integrated loss value being a minimum value in the predetermined number of rounds of iterative training.

As shown in FIG. 8, the apparatus 800 for detecting an image in this embodiment may include: a to-be-detected image receiving unit 801 and an image detecting unit 802. Here, the to-be-detected image receiving unit 801 is configured to receive a to-be-detected image. The image detecting unit 802 is configured to invoke an image detection model to detect the to-be-detected image, the image detection model being obtained through the apparatus for training an image detection model shown in FIG. 7.

This embodiment exists as an apparatus embodiment corresponding to the above method embodiment. According to the apparatus for incrementing a sample image provided in the embodiment of the present disclosure, the candidate region that is likely to contain the target object is determined by means of the region generation network, and then the candidate region with a high probability is used as the target candidate region. By mapping the target candidate region back to the original image, and performing correspondingly sharpening on the portion of the original image corresponding to the target candidate region and/or blurring on the portion of the original image corresponding to the non-target candidate region, the incremental sample image that highlights the target object as much as possible is obtained. Through this technical solution, an incremental sample image with a high availability can be generated under the premise of not destroying the key part of the original sample image.

According to an embodiment of the present disclosure, the present disclosure further provides an electronic device, a readable storage medium and a computer program product.

FIG. 9 is a schematic block diagram of an exemplary electronic device 900 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processer, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 9, the device 900 includes a computing unit 901, which may perform various appropriate actions and processing, based on a computer program stored in a read-only memory (ROM) 902 or a computer program loaded from a storage unit 908 into a random access memory (RAM) 903. In the RAM 903, various programs and data required for the operation of the device 900 may also be stored. The computing unit 901, the ROM 902, and the RAM 903 are connected to each other through a bus 904. An input/output (I/O) interface 905 is also connected to the bus 904.

A plurality of parts in the device 900 are connected to the I/O interface 905, including: an input unit 906, for example, a keyboard and a mouse; an output unit 907, for example, various types of displays and speakers; the storage unit 908, for example, a disk and an optical disk; and a communication unit 909, for example, a network card, a modem, or a wireless communication transceiver. The communication unit 909 allows the device 900 to exchange information/data with other devices over a computer network such as the Internet and/or various telecommunication networks.

The computing unit 901 may be various general-purpose and/or dedicated processing components having processing and computing capabilities. Some examples of the computing unit 901 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 901 performs the various methods and processes described above, such as a method for incrementing a sample image. For example, in some embodiments, a method for incrementing a sample image may be implemented as a computer software program, which is tangibly included in a machine readable medium, such as the storage unit 908. In some embodiments, part or all of the computer program may be loaded and/or installed on the device 900 via the ROM 902 and/or the communication unit 909. When the computer program is loaded into the RAM 903 and executed by the computing unit 901, one or more steps of a method for incrementing a sample image described above may be performed. Alternatively, in other embodiments, the computing unit 901 may be configured to perform a method for incrementing a sample image by any other appropriate means (for example, by means of firmware).

Various embodiments of the systems and technologies described above can be implemented in digital electronic circuit system, integrated circuit system, field programmable gate array (FPGA), application specific integrated circuit (ASIC), application special standard product (ASSP), system on chip (SOC), complex programmable logic device (CPLD), computer hardware, firmware, software, and/or combinations thereof. These various embodiments may include being implemented in one or more computer programs that may be executed and/or interpreted on a programmable system including at least one programmable processor, which may be a dedicated or general programmable processor that may receive data and instructions from a storage system, at least one input device, and at least one output device, and transmit data and instructions to the storage system, the at least one input device, and the at least one output device.

Program codes for implementing the method of the present disclosure may be written in any combination of one or more programming languages. These program codes may be provided to a processor or controller of a general purpose computer, special purpose computer or other programmable apparatus for data processing such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with the user, the systems and techniques described herein may be implemented on a computer having: a display device for displaying information to the user (e.g., a CRT (cathode ray tube) or LCD (liquid crystal display) monitor); a keyboard and a pointing device (e.g., mouse or trackball), through which the user can provide input to the computer. Other kinds of devices can also be used to provide interaction with users. For example, the feedback provided to the user may be any form of sensory feedback (e.g., visual feedback, auditory feedback, or tactile feedback); and the input from the user can be received in any form (including acoustic input, voice input or tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server may be a cloud server, which is also known as a cloud computing server or a cloud host, and is a host product in a cloud computing service system to solve the defects of difficult management and weak service extendibility existing in conventional physical hosts and virtual private servers (VPS).

In the technical solution provided by the embodiments of the present disclosure, a candidate region that is likely to contain a target object is determined by means of a region generation network, and then a candidate region with a high probability is used as a target candidate region. By mapping the target candidate region back to an original image, and performing correspondingly sharpening on the portion of the original image corresponding to the target candidate region and/or blurring on the portion of the original image corresponding to a non-target candidate region, an incremental sample image that highlights the target object as much as possible is obtained. Through this technical solution, an incremental sample image with a high availability can be generated under the premise of not destroying the key part of the original sample image.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for incrementing a sample image, comprising:
acquiring a first convolutional feature of an original sample image;
determining, according to a region generation network and the first convolutional feature, a candidate region and a first probability that the candidate region contains a target object;
determining a target candidate region from the candidate region based on the first probability, and mapping the target candidate region back to the original sample image to obtain an intermediate image; and
performing image enhancement processing on a portion of the intermediate image corresponding to the target candidate region and/or performing image blur processing on a portion of the intermediate image corresponding to a non-target candidate region to obtain an incremental sample image.

2. The method according to claim 1, wherein the performing image blur processing on a portion of the intermediate image corresponding to a non-target candidate region comprises:
performing Gaussian blur processing on the portion of the intermediate image corresponding to the non-target candidate region.

3. The method according to claim 1, wherein the determining a target candidate region from the candidate region based on the first probability comprises:
determining a candidate region having a first probability greater than a preset probability as the target candidate region.

4. The method according to claim 1, wherein the performing image enhancement processing on a portion of the intermediate image corresponding to the target candidate region comprises:
performing first image enhancement processing on a first target region in the intermediate image, wherein the first target region is an overlapping portion of at least two target candidate regions mapped in the original sample image; and
performing second image enhancement processing on a second target region in the intermediate image, wherein the second target region is a portion of a single target candidate region mapped in the original sample image, and an image enhancement intensity of the first image enhancement processing is greater than an image enhancement intensity of the second image enhancement processing.

5. The method according to claim 1, further comprising:
acquiring a second convolutional feature of the incremental sample image;
determining, according to a region generation network and the second convolutional feature, a new candidate region and a second probability that the new candidate region contains the target object;
acquiring a first loss value corresponding to the first probability and a second loss value corresponding to the second probability;
determining an integrated loss value based on a weighted first loss value and a weighted second loss value; and
obtaining a trained image detection model in response to the integrated loss value satisfying a preset requirement.

6. The method according to claim 5, wherein the determining an integrated loss value based on a weighted first loss value and a weighted second loss value comprises:
using a sum of the weighted first loss value and the weighted second loss value as the integrated loss value.

7. The method according to claim 5, wherein the obtaining a trained image detection model in response to the integrated loss value satisfying a preset requirement comprises:
outputting the trained image detection model in response to the integrated loss value being a minimum value in the predetermined number of rounds of iterative training.

8. The method according to claim 5, comprising:
receiving a to-be-detected image; and
invoking the image detection model to detect the to-be-detected image.

9. An electronic device, comprising:
at least one processor; and
a storage device, in communication with the at least one processor,
wherein the storage device stores instructions executable by the at least one processor, and the instructions, when executed by the at least one processor, to cause the at least one processor to perform operations comprising:
acquiring a first convolutional feature of an original sample image;
determining, according to a region generation network and the first convolutional feature, a candidate region and a first probability that the candidate region contains a target object;
determining a target candidate region from the candidate region based on the first probability, and mapping the target candidate region back to the original sample image to obtain an intermediate image; and
performing image enhancement processing on a portion of the intermediate image corresponding to the target candidate region and/or performing image blur processing on a portion of the intermediate image corresponding to a non-target candidate region to obtain an incremental sample image.

10. The electronic device according to claim 9, wherein the performing image blur processing on a portion of the intermediate image corresponding to a non-target candidate region comprises:
performing Gaussian blur processing on the portion of the intermediate image corresponding to the non-target candidate region.

11. The electronic device according to claim 9, wherein the determining a target candidate region from the candidate region based on the first probability comprises:
determining a candidate region having a first probability greater than a preset probability as the target candidate region.

12. The electronic device according to claim 9, wherein the performing image enhancement processing on a portion of the intermediate image corresponding to the target candidate region comprises:
performing first image enhancement processing on a first target region in the intermediate image, wherein the first target region is an overlapping portion of at least two target candidate regions mapped in the original sample image; and
performing second image enhancement processing on a second target region in the intermediate image, wherein the second target region is a portion of a single target candidate region mapped in the original sample image, and an image enhancement intensity of the first image enhancement processing is greater than an image enhancement intensity of the second image enhancement processing.

13. The electronic device according to claim 9, wherein the operations further comprise:
acquiring a second convolutional feature of the incremental sample image;
determining, according to a region generation network and the second convolutional feature, a new candidate region and a second probability that the new candidate region contains the target object;
acquiring a first loss value corresponding to the first probability and a second loss value corresponding to the second probability;
determining an integrated loss value based on a weighted first loss value and a weighted second loss value; and
obtaining a trained image detection model in response to the integrated loss value satisfying a preset requirement.

14. The electronic device according to claim 13, wherein the determining an integrated loss value based on a weighted first loss value and a weighted second loss value comprises:
using a sum of the weighted first loss value and the weighted second loss value as the integrated loss value.

15. The electronic device according to claim 13, wherein the obtaining a trained image detection model in response to the integrated loss value satisfying a preset requirement comprises:
outputting the trained image detection model in response to the integrated loss value being a minimum value in the predetermined number of rounds of iterative training.

16. The electronic device according to claim 13, wherein the operations comprise:
receiving a to-be-detected image; and
invoking the image detection model to detect the to-be-detected image.

17. A non-transitory computer readable storage medium, storing computer instructions, wherein the computer instructions are used to cause a computer to perform operations comprising:
acquiring a first convolutional feature of an original sample image;
determining, according to a region generation network and the first convolutional feature, a candidate region and a first probability that the candidate region contains a target object;
determining a target candidate region from the candidate region based on the first probability, and mapping the target candidate region back to the original sample image to obtain an intermediate image; and
performing image enhancement processing on a portion of the intermediate image corresponding to the target candidate region and/or performing image blur processing on a portion of the intermediate image corresponding to a non-target candidate region to obtain an incremental sample image.

18. The storage medium according to claim 17, wherein the performing image blur processing on a portion of the intermediate image corresponding to a non-target candidate region comprises:
performing Gaussian blur processing on the portion of the intermediate image corresponding to the non-target candidate region.

19. The storage medium according to claim 17, wherein the determining a target candidate region from the candidate region based on the first probability comprises:
determining a candidate region having a first probability greater than a preset probability as the target candidate region.

20. The storage medium according to claim 17, wherein the performing image enhancement processing on a portion of the intermediate image corresponding to the target candidate region comprises:
performing first image enhancement processing on a first target region in the intermediate image, wherein the first target region is an overlapping portion of at least two target candidate regions mapped in the original sample image; and
performing second image enhancement processing on a second target region in the intermediate image, wherein the second target region is a portion of a single target candidate region mapped in the original sample image, and an image enhancement intensity of the first image enhancement processing is greater than an image enhancement intensity of the second image enhancement processing.
